(19) United States
(12) Patent Application Publication
(10) Pub. No.: US 2007/0245568 A1
(43) Pub. Date: Oct. 25, 2007

(54) Demolition claw

(75) Inventors: Sebastian Schipp, Essen (DE); Gyorgy Bodis, Langenfeld (DE)

Correspondence Address: K.F. ROSS P.C., 5683 RIVERDALE AVENUE, SUITE 203 BOX 900, BRONX, NY, 10471-0900, US

(73) Assignee: ATLAS COPCO CONSTRUCTION TOOLS GMBH

(21) Appl. No.: 11/789,028

(22) Filed: Apr. 23, 2007

(30) Foreign Application Priority Data
Apr. 23, 2006 (DE) 102006019069.6

(51) Int. Cl. B25F 3/00; B26B 11/00

(52) U.S. Cl. 30/134

(57) ABSTRACT

A demolition claw has a pair of jaws, one of which is pivotal relative to the other about an axis between an inner position with inner faces of the jaws closely confronting each other and outer positions with the inner faces spread apart. The one jaw has a tip directed away from the axis. A wear shoe fittable to the inner face of the one jaw is formed with a recess open toward the axis and fitting over the tip of the one jaw. A fastener subassembly releasably fixes the shoe to the inner face of the one jaw with the tip fitted in the recess such that the shoe cannot move relative to the one jaw.

### FIELD OF THE INVENTION

The present invention relates to a demolition claw. More particularly this invention concerns a demolition claw with replaceable jaw faces or shoes.

### BACKGROUND OF THE INVENTION

A demolition claw has a pair of jaws that are pivoted together and one of which is movable between a closed position close to or even, fitting with the other jaw and an open position spaced from the other jaw, which may be fixed or movable. The confronting faces of the two jaws are provided with replaceable wear shoes typically formed with inwardly directed teeth. Such a claw is mounted at the end of an outrigger arm of a piece of construction equipment and is used to grip and even crush objects. A typical job for such a claw is in the demolition of a building, and the crushing action can be used to break up reinforced concrete and even separate the steel thereof from the concrete.

During rough operation of heavy-duty comminuting machines, the work surfaces directly contacting the material to be crushed are subjected to high wear. To avoid having to replace a complete jaw as the result of wear, it is known to provide the jaws with detachable wear shoes. Although the screw connections originally used for attaching the wear shoe have the advantage that over its service life the wear shoe is securely fastened to the respective jaw, use of numerous screws entails laborious screwing and unscrewing operations. In addition, screws which engage in threaded holes of the jaw are not always adequately secured against coming loose, so that before they are affected by wear the screws must often be retightened. The shoe-replacement operation is very time-consuming. If a screw cannot be unscrewed on-site because of an inaccessible location, it is even necessary to take the entire demolition claw to the shop to perform repairs.

Thus, in U.S. Pat. No. 5,474,242 describes a device having two jaws pivotable about a common axis, and each jaw carries a holder on which an insert is mounted. In particular, the holder has an outer face that may be mounted on an inner face of the jaw of an manipulator, and has an inner face opposite the outer face and having inner and outer ends. The inner holder face has an elongated intermediate portion, an inclined end portion adjoining the inner end and extending away from the intermediate portion toward the inner end, and a inner recess in the inner inclined end portion. The insert has an inner face for engaging with workpieces and an outer face, opposite the inner face, that is mounted on the inner face of the holder. The insert also has inner and outer ends and its outer face has an elongated intermediate portion contacting the elongated intermediate portion on the holder, an inclined end portion adjoining the inner end and extending from the intermediate portion toward the inner end and contacting the inclined end portion of the holder, and a spine projecting from the elongated portion and extending along same, the spine being seated in a groove of the holder and having a projection adjacent to the inner end that is seated in the holder recess. The outer end of the insert is secured via fastening means to the outer end of the holder.

For assembly, the insert together with the projection must be inserted into the recesses in the holders, after which the projection is pivoted about the recesses so that the contact surfaces of the holder and of the insert are brought together until contact is made. During the pivoting various faces engage with one another, thereby preventing displacement of the insert parallel to the contact surface. A disadvantage of this design is the use of a holder that is necessary as an additional component. Furthermore, in this design the severely stressed tip of the jaw is not protected by the wear element, so that for operations in which material is picked up from the ground, or the tips of the jaws come into contact with the workpieces, protection against wear is insufficient at that location. In addition, the described design cannot be used in comminuting devices in which a jaw has two axially spaced cheeks, so that the jaw is open between the cheeks, as is necessary for instance for crushing so that the crushed material can pass through the space between the cheeks.

### OBJECTS OF THE INVENTION

It is therefore an object of the present invention to provide an improved demolition claw.

Another object is the provision of such an improved demolition claw that overcomes the above-given disadvantages, in particular that has easily replaced jaw wear shoes that completely protect the permanent jaw structure, especially in an open-type jaw.

### SUMMARY OF THE INVENTION

A demolition claw has according to the invention a pair of jaws, one of which is pivotal relative to the other about an axis between an inner position with inner faces of the jaws closely confronting each other and outer positions with the inner faces spread apart. The one jaw has a tip directed away from the axis. A wear shoe fittable to the inner face of the one jaw is formed with a recess open toward the axis and fitting over the tip of the one jaw. A fastener subassembly releasably fixes the shoe to the inner face of the one jaw with the tip fitted in the recess such that the shoe cannot move relative to the one jaw.

As a result of this construction, the tip of the jaw to which the wear shoe is attached is securely covered and protected. In addition, the wear shoe is blocked in all directions relative to the jaw.

Furthermore, according to the invention, at its inner faces the wear shoe makes direct contact with the inner side of the jaw so that the forces applied during use and acting perpendicularly on the working surface of the wear shoe are transmitted directly to the jaw. At the same time, the contact surfaces of the wear shoe on the jaw prevent any fastening screws or bolts from being subjected to stress.

Assembly and disassembly of the wear shoe on the respective jaw is greatly simplified by the design according to the invention. For assembly, the wear shoe must be pushed onto the jaw, i.e. the tip of the jaw, or onto a projection at that location, and then placed against the jaw and locked using a fastener. As will be described below, such locking may also be securely achieved when the wear shoe has been manufactured using simple means, i.e. without complex milling operations, since narrow tolerances between the components are not necessary. The wear shoe may be manufactured as a welded design or by casting or forging, which minimizes costs. Special final machining or adjustment/resetting operations are not necessary during installation, thereby ensuring an economical application for this sacrificial part. For devices that operate in particular as crushers, a jaw having two parallel cheek plates is used. These cheeks preferably have upper support edges that act as the inner support surface for longitudinal faces of longitudinal members for the wear shoe.

According to one preferred embodiment, at least one transverse bar is fixed between the cheeks of the jaw. The wear shoe preferably also has transverse bars, as well as a transverse face, located between two transverse members, which has at least one pair of openings through which the legs of a U-shaped clip, which for a wear shoe mounted on the support surface of the cheeks are located on both sides of the transverse bar, may be inserted. During installation, when the wear shoe is pushed onto the tips of the cheeks, the longitudinal members of the wear shoe are brought into contact with their edges, after which one, preferably two, U-shaped fastener clips are inserted through the openings in the shoe, so that all relative motion in the longitudinal direction of the jaw is blocked by corresponding positioning of the openings and the transverse faces. To prevent the U-shaped clip from coming loose, transverse bolts may be used that serve as a connection between the two legs.

According to an alternative embodiment, one, preferably two, U-shaped clips are placed from above on at least one transverse member of the wear shoe, the two legs of a U-shaped clip flanking the respective transverse member and resting against either side of a transverse bar of the jaw, which is located beneath the respective transverse member between the two cheeks. It is therefore unnecessary to provide a transverse face between two transverse members of the wear shoe for accommodating a U-shaped clip. To prevent the U-shaped clip from coming loose, once again transverse bolts may be used that serve as a connection between the two legs. The transverse bolts may also be guided through a hole in the transverse bar, thus providing further protection of the wear shoe against relative transverse to the longitudinal direction of the jaw, and also against lifting.

In a modification of the above-referenced embodiment, one, preferably two, U-clips are fitted from inside on at least one transverse bar of the jaw, the two legs of a U-shaped clip overlapping the respective transverse bar and resting against either side of a transverse member of the wear shoe. For fixing the U-clip in place, the two legs are connected by a transverse bolt that is guided through a hole in the transverse member of the wear shoe. Such an arrangement of the U-clip likewise blocks motion of the wear shoe in all directions relative to the jaw.

Regardless of the particular position of the transverse members of the wear shoe or of the transverse bar of the jaw, securing may also be achieved by placing at least one U-shaped clip above one, preferably both, longitudinal members of the wear shoe, the two legs of a U-shaped clip overlapping the respective longitudinal member and resting against either side of a cheek of the jaw. For position fixing, the cheek has a hole through which a transverse bolt is guided, thereby connecting the two legs of a U-shaped clip.

According to a further preferred embodiment, a transverse bar of the jaw is designed, at least in part, as a transverse metal sheet or plate that lies atop the inner support edges of the cheeks. Each of the longitudinal faces of the longitudinal members also has a recess that fits complementarily with the width and height of a transverse metal sheet. When the longitudinal member is placed on the support surfaces, the wear shoe lies flush also in the region of the transverse metal sheet, with a small amount of play. The wear shoe is thus blocked against movement in the longitudinal direction of the jaw, that is perpendicular to the pivot axis and parallel to the jaw inner face.

In one preferred design of the demolition claw, the wear shoe has two grooves forming a hook-shaped extension of the longitudinal members, each of the recesses engaging with a cheek of the jaw or a projection provided on the tip. This hook design simplifies handling of the wear shoe during installation.

In one alternative design, i.e. for a crusher having a jaw with a closed profile, there is inside the jaw at least one or two on each side of a center rib that engages with the wear shoe on its back. On its front, hook-shaped extensions of the longitudinal members the wear shoe have grooves on either side that engage with the tip of the jaw or the projections provided at that location. In principle, in these system hooks are used on both the front and back sides that engage or are attached diagonally on opposite sides of the wear shoe, so that when the wear shoe is pushed toward the pivot axis the wear shoe can be forcibly pushed until it reaches the end stop position of the wear shoe, thus allowing the wear shoe to be locked, for example by use of insertable profiles that may be pushed in perpendicular to the support faces, that is generally tangentially of the pivot axis. A fastener attaches the wear shoe to a U-shaped clip on the jaw via a transverse bolt that passes through the jaw as well as the leg of the U-shaped clip. Here as well, a bolt or a bolt-nut connection is used solely as a cross bracket, so it does not require a highly accurate fit.

The fastener, which in particular is a U-shaped clip, preferably can also be formed with a tooth on its side facing away from the jaw. Such a tooth, made of very hard cast metal, is useful in breaking concrete.

According to a further embodiment of the invention, the longitudinal members on the side facing away from the jaw, i.e. on their support edges, have tooth-like projections that protrude beyond the fastener, optionally with the exception of a tooth fastened thereto, in the installed state. The fastener or parts thereof are thus prevented from coming into direct contact with the material being crushed.

The claw according to the invention has an open, stationary jaw having two cheeks, and a closed jaw that is rotatable with respect to same, thus allowing use as a crusher.

### BRIEF DESCRIPTION OF THE DRAWING

The above and other objects, features, and advantages will become more readily apparent from the following description, reference being made to the accompanying drawing in which:

FIG. 1a is a perspective view of a demolition claw in fully assembled condition;

FIG. 1b shows the same device in an exploded perspective view;

FIG. 2a is a perspective view of a wear shoe attached to a double-wall jaw according to another design of the demolition claw according to the invention;

FIGS. 2b and 2d are views showing a variations on the device according to the invention;

FIG. 2d is a view like FIG. 2a showing another variation on the jaw according to the invention;

FIGS. 3a and 3b are detail perspective views of wear shoes attached to a jaw according to further designs of the demolition claw according to the invention;

FIG. 3c is a perspective view of the wear shoe of FIG. 3a;

FIG. 4 is a detail side view of another wear shoe attached to a jaw;

FIGS. 5 and 6 are views like FIGS. 3 and 4 of another variation on the jaw assembly;

FIGS. 7 and 8 are different views of a wear shoe on a closed-body jaw;

FIG. 9 is a view of only the wear shoe according to FIGS. 7 and 8; and

FIG. 10 is a bottom view showing a wear shoe having lateral contact surfaces.

### SPECIFIC DESCRIPTION

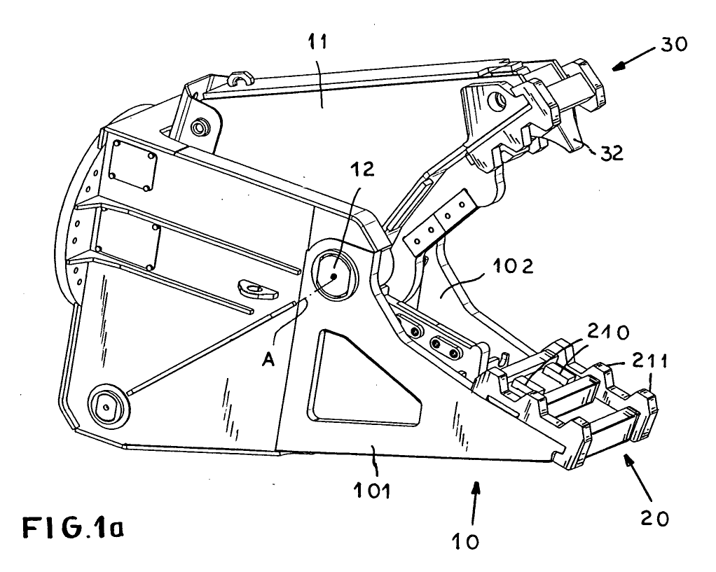

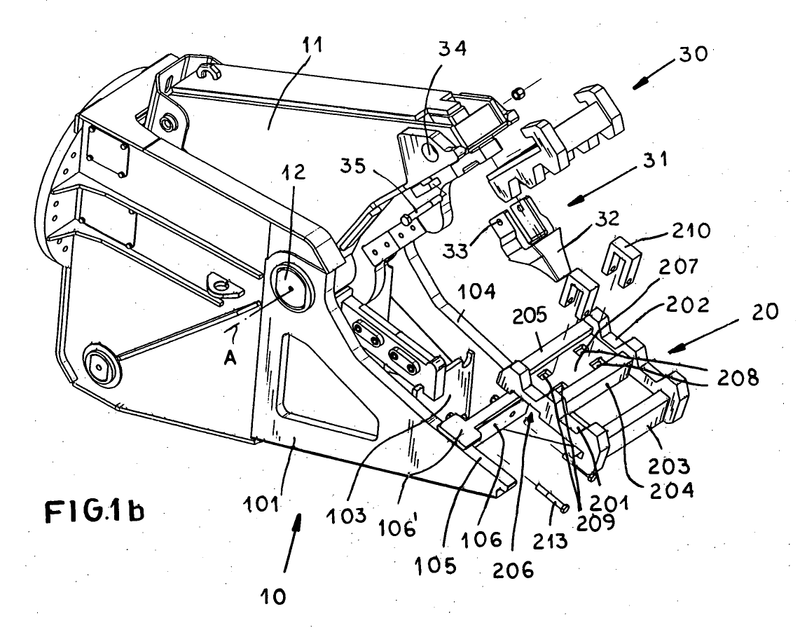

As seen in FIG. 1a, a demolition claw has two jaws 10 and 11, the lower jaw 10 having two cheek plates 101 and 102 spaced along a pivot axis A from each other and connected by a transverse bar or member 103, although several such members 103 could be used. A wear shoe 20 is mounted on the inner face of the jaw 10. The jaw 11 has a closed design, and is provided as a support for a wear shoe 30 mounted on its inner face, that is its face turned toward the inner face of the jaw 10. In the illustrated embodiment, the upper jaw 11 is movable about axis A of the joint 12 so that at its inner face of the upper jaw can be moved in the direction toward and away from the inner face of the stationary lower jaw 10.

The wear shoe 20 has longitudinal members 201 and 202 that are connected to one another via transverse members 203, 204, and 205. The parallel cheeks 101 and 102 have inner support edges 104 and 105 that carry the longitudinal members 201 and 202, and that therefore form the respective inner support face.

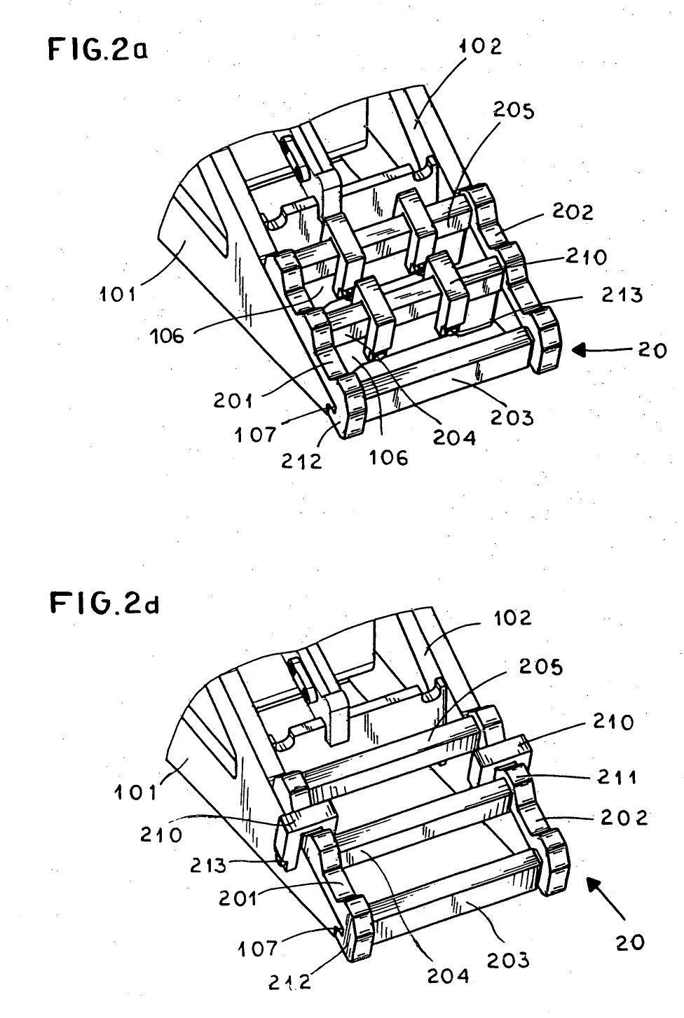

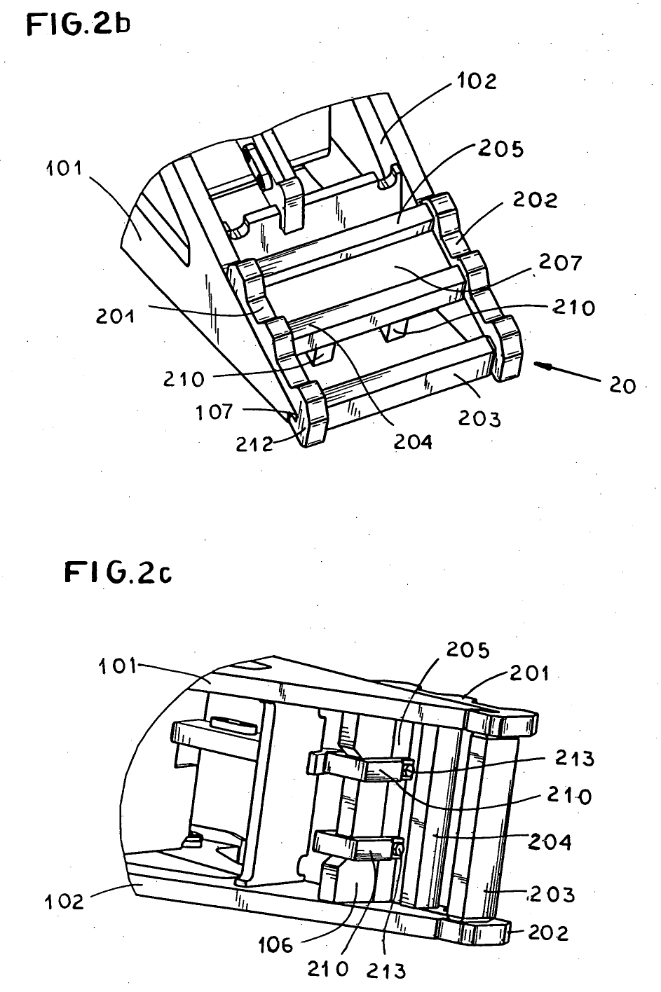

According to the embodiment illustrated in FIG. 2a, two transverse bars 106 are provided between the cheeks 101 and 102 such that the inner faces of the bars 106 form a support surface for transverse members 204 and 205 of the shoe 20, whereas the longitudinal outer faces of the longitudinal members 201 and 202 rest on the inner support edges 104 and 105 of the respective cheek 101 and 102. The longitudinal members 201 and 202 for the wear shoe 20 also have as hook-shaped extensions 212 forming two grooves or recesses 215 that in the assembled condition engage with each tip of a cheek 101 and 102 of the jaw 10 or engage with projections or tips 107 of the cheek plates 101 and 102. The hook-shaped extensions 212 for the two longitudinal members 201 and 202 prevent relative motion of the wear shoe 20 in a longitudinal direction of the jaw 10 radially toward the axis A. Such movement, as well as longitudinal movement in the opposite direction, is also blocked by two pairs of fasteners or U-clips 210 that are fitted over the transverse members 204 and 205, the legs of the fasteners 210 flanking and extending past the transverse members 204 and 205 and resting against radial inner and outer faces of the transverse bars 106 of the jaw 10. Each of the U-shaped clips 210 is also secured by a transverse bolt 213 that connects the legs of the respective U-shaped clip 210 and fit through a hole in the respective transverse bar 106. This design also prevents the wear shoe from lifting up, i.e. undergoing relative inward motion with respect to the jaw 10, to prevent the longitudinal members 201 and 202 from losing contact with the support edges 104 and 105 of the cheeks 101 and 102.

FIGS. 2b and 2c show an alternate embodiment of a demolition claw, in FIG. 2b a detailed perspective view from above and in FIG. 2c a detailed perspective view from below. The illustrated wear shoe 20 essentially corresponds to that in FIG. 2a, except that a web plate forms a transverse inwardly directed face 207 between the transverse members 204 and 205. A further difference from the embodiment according to FIG. 2a is that two U-shaped fasteners 210 are mounted from below on a transverse bar 106 of the jaw 10, the legs of the U-shaped clips 210 flanking the transverse bar 106 and resting on either side of the transverse member 205. For fixing the position, the two legs of each U-shaped clip 210 are connected by a respective transverse bolt 213 that is guided through a hole in the transverse member 205. Thus, as in the preceding embodiment any relative motion of the wear shoe 20 with respect to the jaw 10 is blocked.

FIG. 2d shows a further embodiment of the invention. The wear shoe 20 also has transverse members 203, 204 and 205 between the longitudinal members 201 and 202, but additional transverse bars 106 between the cheeks 101 and 102 of the jaw 10 are omitted. For fixing the position, once again two U-clips 210 are used, each of which is mounted on a longitudinal member 201 and 202. The two legs of each clip 210 flank the longitudinal members 201 and 202, and in this case rest on either side of the cheeks 101 and 102. The cheeks 101 and 102 each have a hole through which a transverse bolt 213 connecting the two legs of a U-shaped clip 210 is inserted.

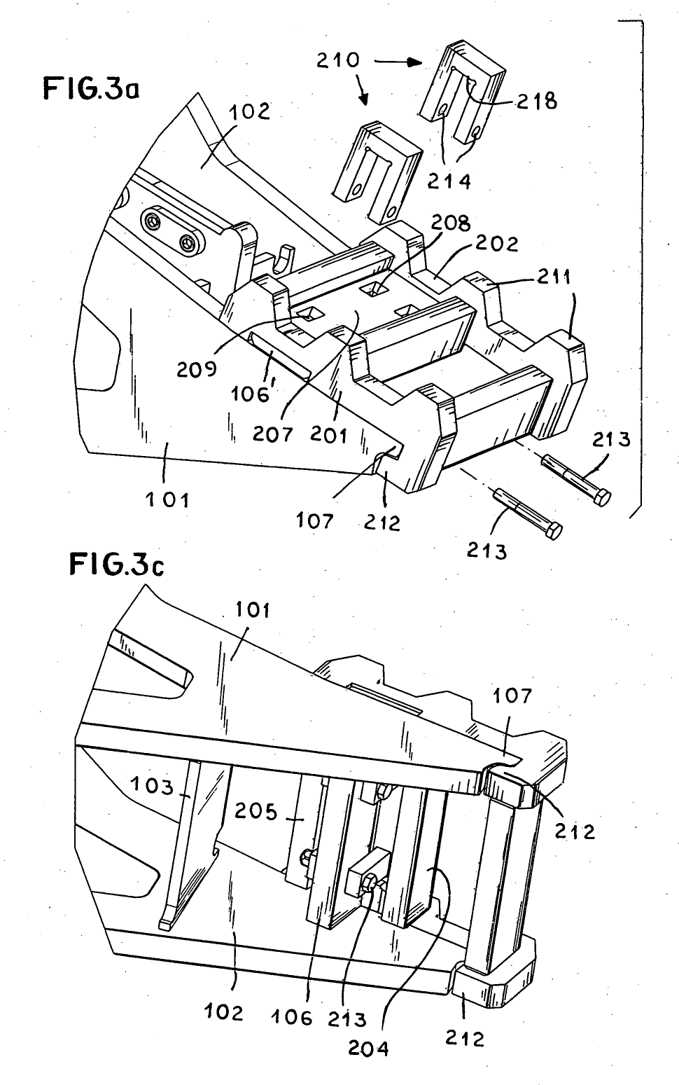

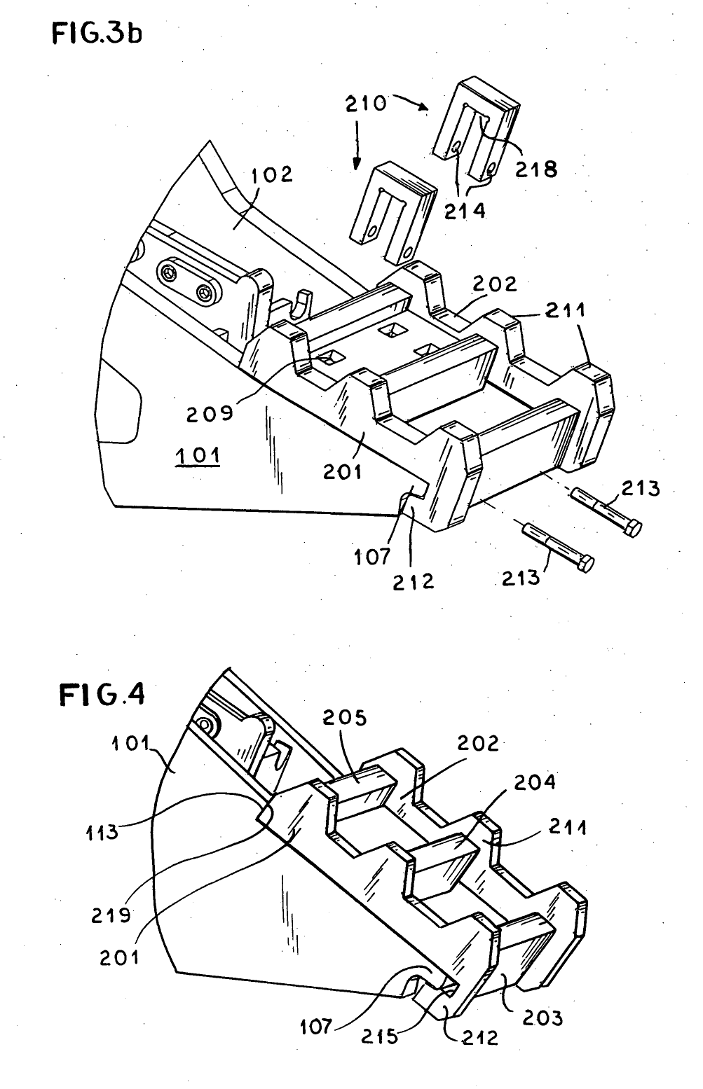

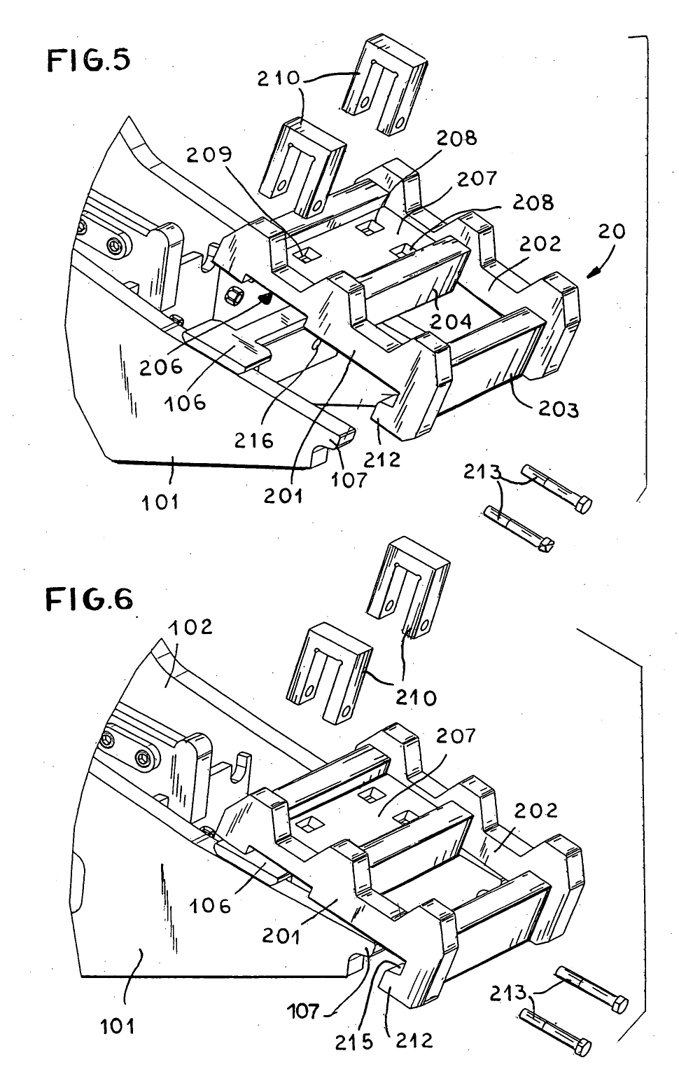

As previously shown in FIGS. 1a and 1b, according to one preferred illustrated embodiment the support edges 104 and 105 are also bridged by a transverse metal sheet 106′ that is wider at both ends at the support edges 104 and 105 than in the middle. Complementary to the height and width of the transverse metal sheet, each of the longitudinal members 201 and 202 has a recess 206 that according to the illustration in FIG. 3a is matched to the dimensions of the transverse metal sheet 106′, thereby blocking relative motion in the longitudinal direction of the cheek 101 or 102. The wear shoe 20 also has an additional transverse face 207 having two pairs of openings 208 and 209 through which the legs of U-shaped clips 210, which for a wear shoe 20 mounted on the support edges 104 and 105 of the cheek are located on both sides of the transverse bar 106, may be inserted. On its upper side the wear shoe 20 also has teeth 211 that project past the transverse members 203, 204, and 205 as well as the inserted U-shaped clip (see FIG. 1a). Hooks 212 that form grooves and that in each case engage with a projection 107 of the cheeks 101 and 102 are primarily used for locking the wear shoe 20. After the wear shoe has been pushed and pivoted into the position illustrated in FIG. 3a or 3b, the longitudinal members 201 and 202 rest against the faces 104 and 105, and in the design in FIG. 3a rest against the ends on both sides of the transverse metal sheet 106′. The U-shaped clips 210 are then inserted into the openings 208, 209, after which the bolts 213 are pushed through the holes 214 and at that location are locked by means of lock nuts as shown in FIG. 3c. The free legs of the U-shaped clip thus engage the transverse metal sheet 106′, so that the wear shoe 20 cannot be displaced in either toward or away from the axis A. A U-clip 210 having two holes 214 through which the bolts 213 are likewise inserted is used for fixing in the horizontal direction; i.e. the holes 214 must be brought into an overlapping position with the corresponding holes in the transverse bar 106 with a crosspiece 218 of the clip 210 resting on the bar 106.

The advantage of the previously described design, as well as in the design according to FIGS. 2b and 2c, is that the fastening and locking means, namely, the U-shaped clips 210 and the bolts 213, are protected, i.e. completely or at least partially beneath the transverse face 207, and are subjected to no significant contact with whatever the demolition clip is being used on. All forces act on the wear shoe 20, which as the result of being supported on the faces 104 and 105 directly transmits the forces.

Also included within the scope of the present invention are embodiments in which, instead of a projection 107, the tips of the jaws 101 and 102 are fitted in recesses in a wear shoe 20. It is also possible to mount an additional transverse bar or transverse member at the tip of the two cheeks 101 and 102, which then fits in a long complementary comes of the wear shoe 20. The projections 107 as well as the recess or groove prevent the wear shoe from moving toward the axis A.

Since movement of the wear shoe 20 toward the axis A is also blocked by inserting the U-clips 210 corresponding to FIGS. 2a through 2d and 3a through 3c (in FIG. 2d by supporting the U-shaped clips 210 on the toothed projections 211), a full positive fit of the tip of the cheek 101 and 102, or the projection 107 provided thereon, with the groove-shaped recesses 215 of the hooks 212 of the longitudinal members 201 and 202 is not necessary. Thus, according to a further preferred embodiment (FIG. 4), in the installed state the hook-shaped extensions 212 of the longitudinal members 201 and 202 engage with the tips of the cheeks 101 and 102 or the projections 107 provided thereon in such a way that the wear shoe 20 is prevented from lifting up in the front region that is the part furthest from the axis A. Relative motion in the longitudinal direction with respect to the rotary joint 12 is blocked by the mutually contacting stop surfaces or abutment shoulders 219 (for the wear shoe 20) and 113 (for the cheeks 101 and 102).

While the wear shoe 20 is prevented from lifting up at the tip as the result of the hook design in the front region, the wear shoe 20 is prevented from lifting up in the rear region by the engaging bolts 213 (illustrated embodiment according to FIGS. 2a through 2d and 3a through 3c). The wear shoe 20 thus projects beyond the tip or encloses same so that the tip of the jaw 10 is securely protected against wear. Forces acting perpendicular to the direction of the jaw 10 are directly transmitted by the wear shoe 20 to the cheeks 101 and 102. The transverse metal sheet 106′ located inside the recess 206 (illustrated embodiment according to FIGS. 1a, 1b and 3a, 3c) is optionally used as a further means for preventing longitudinal displacement in the direction of the tip toward the jaw 10. The hook-shaped recesses on the wear shoe in conjunction with the projections 107, as well as the faces of the transverse metal sheet 106′ and the recess 206 and the transverse bars 204 and 205, are designed such that the wear shoe may be pivoted slightly about the projection 107 for disassembly, or for assembly may be correspondingly pivoted in until the longitudinal faces of the wear shoe come to rest on the edges 104 and 105. The number of transverse members 203, 204, and 205 may also be smaller or greater than illustrated in the illustrated embodiment, depending essentially on the length and the width of the face to be protected. For crushers, however, it is important for free space to remain between the two cheeks 101 and 102 through which particles of the crushed material can fall. Longitudinal profiles having an expanded head may also be used instead of the U-shaped profile 210.

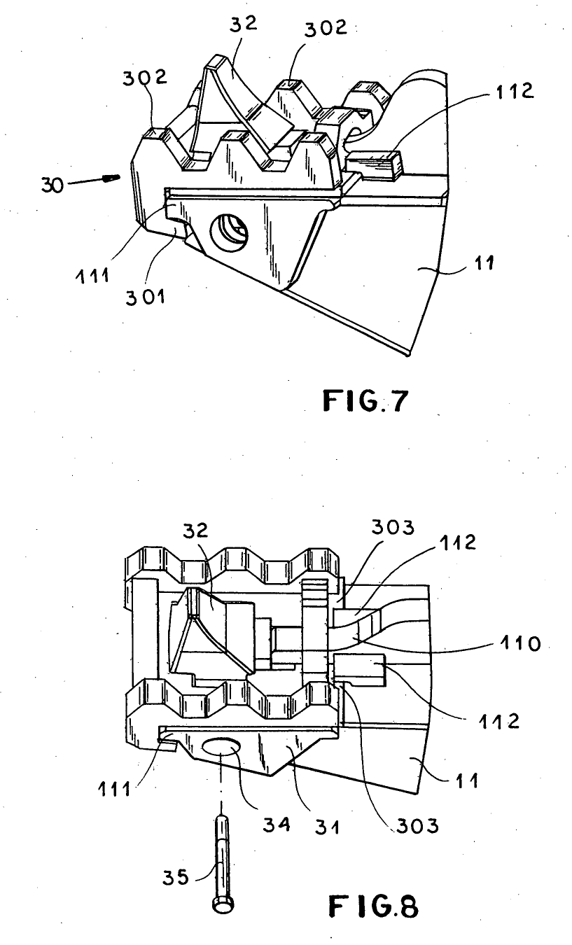

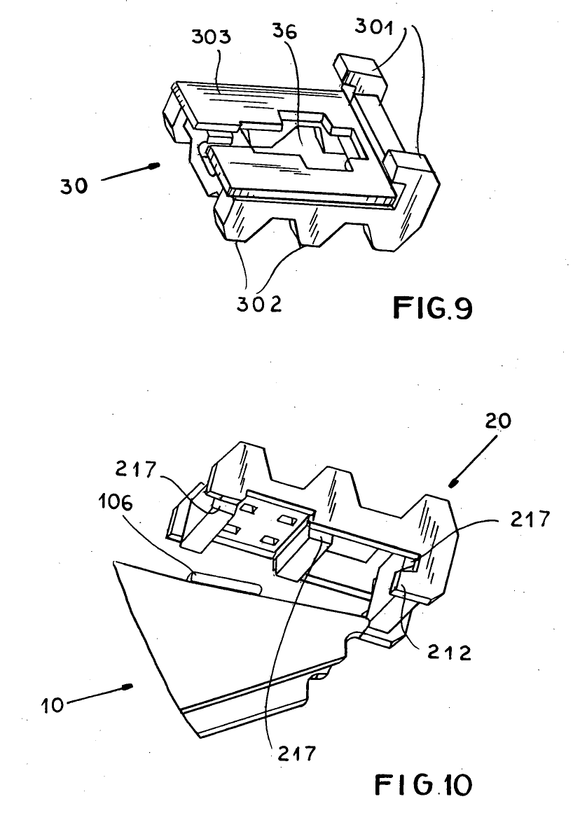

The U-shaped clip 210 can also carry a wear tooth projecting away from the jaw. FIGS. 7 through 9 show that on the jaw 11, which is designed as a closed profile, a wear shoe 30 is used that has hook-shaped extensions 301 that each form a recess in which the respective tip 111 of the jaw fits. The jaw 11 also has a center plate or rib 110 in addition to two hooks 112 that engage over a base plate 303 of the wear shoe 30 (see FIG. 9) at the rear end. Motions in the longitudinal direction of the jaw 11 as well as perpendicular to the support edges, i.e. perpendicular to the base profile, are thus blocked by the hooks 112 and the hooks 301. The wear shoe 30 also has a center recess that corresponds in width to the center rib 110 (see FIG. 8). FIGS. 1 and 2 also show how a U-shaped clip 31 at the end facing the jaw 10 is designed as a wear tooth 32. The wear tooth 32 projects beyond the teeth 302 on the top side of the wear shoe 30. In the installed state, at a contact surface facing the jaw 11, the tooth 32 rests against the base profile 303 of the wear shoe. Also used for securing the wear shoe is the U profile 31, that has two holes 34 through which a bolt 35 may be passed as well as through similar holes in the jaw 11. The U-shaped clip 31 passes through the opening 36 and rests against inner contact surfaces of the jaw 11, thereby also blocking transverse motions transverse to the longitudinal axis of the jaw 11.

Motion in the plane of the support edges parallel to the rotational axis is prevented by the fact that outer faces of the wear shoe rest against inner faces of the jaw 11. Inner faces of the longitudinal members of the wear shoe may also engage with outer faces of the cheeks.

In FIG. 10, faces 217 are illustrated that in the installed state come to rest against the inner sides of the cheeks 101 and 102. A face 217 may also be provided in the region of the hooks so that the projections 107 form the complementary face on the jaw side. Thus, U-clips only prevent the wear shoe from lifting up or pivoting; all other movement blocked by means of contacting faces between the wear shoe and the cheeks or transverse bar.

The wear shoes 20, 30 may be economically manufactured as forged or cast parts, or also as simple welded assemblies.

We claim:

1. A demolition claw comprising:
a pair of jaws, one of the jaws being pivotal relative to the other of the jaws about an axis between an inner position with inner faces of the jaws closely confronting each other and an outer position with the inner faces spread apart, the one jaw having an end tip extending away from the axis;
a wear shoe fittable to the inner face of the one jaw and formed with a recess open toward the axis and fitting over the tip of the one jaw; and
fastener means for releasably fixing the shoe to the inner face of the one jaw with the tip fitted in the recess such that the shoe cannot move relative to the one jaw.

2. The demolition claw defined in claim 1 wherein the one jaw has
a pair of axially spaced and generally parallel cheek plates having inner edges forming the respective inner face, and
a transverse bar fixed to the plates and extending therebetween generally parallel to the axis.

3. The demolition claw defined in claim 2 wherein the fastener means includes a bolt element and a U-shaped clip element having a pair of legs, the bolt element being engageable between the legs of the clip element, the legs of the clip element flanking the bar, one of the elements engaging the bar and the other of the elements engaging the shoe.

4. The demolition claw defined in claim 2 wherein the shoe has a plate formed with a pair of holes through which project the legs of the clip element.

5. The,demolition claw defined in claim 4 wherein the shoe has side members resting on the edges of the respective cheek plates and cross bars fixed to the side members and extending generally parallel to the axis therebetween, the side members and cross bars having inner faces turned away from the one jaw and higher than the crosspiece of the clip, the clip being recessed below the side members and cross bars.

6. The demolition claw defined in claim 4 wherein the clip element has a crosspiece bearing on the plate.

7. The demolition claw defined in claim 4 wherein the clip element has a crosspiece bearing on the bar.

8. The demolition claw defined in claim 2 wherein the shoe has parallel longitudinal side members resting on the edges of the cheeks and at least one cross bar fixed to and extending generally parallel to the axis between the side members.

9. The demolition claw defined in claim 7 wherein the fastener means includes
a U-shaped clip having a pair of legs flanking one of the side members and the respective cheek plate and a cross piece bearing on the one side member, and
a bolt extending through the legs and through the cheek plate.

10. The demolition claw defined in claim 2 wherein the shoe has
two side members sitting on the edges of the cheek plates and
at least one bar fixed to and extending generally parallel to the axis between the side members.

11. The demolition claw defined in claim 10 wherein the cheek plates have outer ends forming the tip and the side members each have an outer end formed with a hook forming the recess receiving the tip.

12. The demolition claw defined in claim 11 wherein the shoe also has an end bar formed with a groove receiving the tip.

13. The demolition claw defined in claim 10 wherein each side member has a U-section part fitting over the respective cheek plate, each part and the respective side plate being formed with aligned holes, the fastener means including a bolt projecting through the holes.

14. The demolition claw defined in claim 10 wherein each side member is formed with at least one tooth projecting away from the respective jaw.

15. The demolition claw defined in claim 2 wherein the fastener includes a clip engaging and fitting with the shoe and the one jaw, the clip being formed with an tooth projecting away from the one jaw.

16. The demolition claw defined in claim 2 wherein both jaws have such cheek plates but the one jaw is open between its cheek plates and the other jaw is closed between its cheek plates.

17. The demolition claw defined in claim 2 wherein in an unfastened condition the shoe is pivotal at the recess and tip relative to the one jaw.
